(19) United States
(12) Patent Application Publication
(10) Pub. No.: US 2021/0247828 A1
(43) Pub. Date: Aug. 12, 2021

(54) Sequenced Sensor Power Management for Extended Battery Life of Trapped Occupant Detectors

(71) Applicants: Michael T. Gage, Garland, TX (US); Robert H. Frantz, Oklahoma City, OK (US)

(72) Inventors: Michael T. Gage, Garland, TX (US); Robert H. Frantz, Oklahoma City, OK (US)

(21) Appl. No.: 17/169,502

(22) Filed: Feb. 7, 2021

Related U.S. Application Data
(60) Provisional application No. 62/975,098, filed on Feb. 11, 2020.

(51) Int. Cl. G06F 1/30; G08B 21/02

(52) U.S. Cl. CPC G06F 1/30; G08B 21/02

(57) ABSTRACT

Power management processes and circuits for battery-powered abandoned occupant or trapped occupant detectors are disclosed in which power to at least two families of sensors are controlled independently by a control process or circuit, wherein a first family of sensors is lower power consuming and suitable for periodic or continuous monitoring, and wherein at least a second family of sensors is higher power consuming and suitable for more certain determination of a dangerous condition currently existing or potentially existing soon. The second family is disabled from consuming power until at least one sensor of the first family detects at least an initial condition indicative of a possible dangerous condition.

### INCORPORATION BY REFERENCE

U.S. Pat. No. 10,217,344, issued Feb. 26, 2019, entitled “Noxious Gas Alert And Remediation System” and U.S. Pat. No. 10,457,200, issued Oct. 29, 2019, both to Michael T. Gage, et al., are incorporated herein, in their entireties, including drawings.

### FIELD OF THE INVENTION

This patent application claims benefit of the filing date of U.S. Provisional Patent Application Ser. No. 62/975,098, our docket MGRF2020003P, filed on Feb. 11, 2020, by Michael T. Gage, et al. The invention generally relates technologies to detection of and alerting to an abandoned or trapped child, adult, or pet in an enclosed space that represents a suffocation hazard.

### BACKGROUND OF INVENTION

Children and pets, and sometimes even adults, suffocate when they become trapped in an enclosure such as a freezer, refrigerator, hope chest, gun safe, locker, vehicle trunk, etc. All of these enclosures are large enough for a child, pet or even adult to enter into, either voluntarily such as during playing or exploring, or involuntarily such as during the commission of a crime, smuggling, etc. Many municipalities, states and national governments have passed laws and regulations to try to prevent such deaths, such as a requirement to remove latches from unused freezers and refrigerators or to provide a glow-in-the-dark release handle inside vehicle trunks, but these measures are only effective when the victims are aware of the option and/or are physically capable of operating the release, door, etc. For example, three young children died in January of 2019 in Suwanee County, Fla., when they climbed into an empty, unplugged chest-style freezer, and closed the lid. A hasp for a padlock fell down and prevented them from re-opening the lid. The caregiver and another adult noticed the children missing almost immediately, and searched the home's property for 30-45 minutes before they found the three children lifeless in the freezer. In another tragic example, in January of 2014, two children ages 7 and 8 in Franklin, Mass., died after climbing into a hope chest or cedar chest and having the lid close and latch on them, which was not operable from the inside of the chest. And, much more recently, a 3-year old boy in Mustang, Okla., suffocated in November of 2019 after climbing into a hope chest and having the lid latch closed.

### SUMMARY OF THE INVENTION

Power management processes and circuits for battery-powered abandoned occupant or trapped occupant detectors are disclosed in which power to at least two families of sensors are controlled independently by a control process or circuit, wherein a first family of sensors is lower power-consuming and suitable for periodic or continuous monitoring, and wherein at least a second family of sensors is higher power-consuming and suitable for more certain determination of a dangerous condition currently existing or potentially existing soon. The second family is disabled from consuming power until at least one sensor of the first family detects at least an initial condition indicative of a possible dangerous condition.

### BRIEF DESCRIPTION OF THE DRAWINGS

The description set forth herein is illustrated by the several drawings.

FIG. 1 depicts an example logical process according to the present invention.

FIG. 2 illustrated an example high-level block diagram of a system architecture according to the present invention.

### DETAILED DESCRIPTION OF EMBODIMENT(S) OF THE INVENTION

The inventors of the present invention have recognized a problem in the art not previously recognized or addressed regarding detection of and alerting to trapped occupants of enclosures such as freezers, refrigerators, hope chests, storage lockers, shipping containers, gun safes, vehicle trunks, vehicle interiors and the like. While many of these appliances and products provide highly technologically advanced safety features such as water leak detectors, open door detectors (to prevent spoilage of food and to detect unauthorized opening), automatic braking, lane departure warnings, etc., they do not provide a detector and/or alert system for an occupant such as a child, adult, or pet which is trapped or abandoned within the enclosure.

### Detection of Abandoned Occupant(s)

There are known methods for detecting occupants of a disclosure using sensors such as weight sensors, door status switches, passive infrared (PIR) motion sensors, accelerometers, and ultrasonic proximity sensors. The present co-inventors have been awarded U.S. Pat. No. 10,217,344 (Feb. 26, 2019) entitled “Noxious gas alert and remediation system” and U.S. Pat. No. 10,457,200 (Oct. 29, 2019) entitled “Abandoned occupant danger alert system”, both of which are directed at detecting CO₂ exhaled by trapped or abandoned occupants of an enclosure, such as a vehicle, in order to more reliably alert the vehicle owner or operator, passersby, and/or rescue services. Any or all of these technologies, alone or in various combinations, are suitable for benefiting from the power management invention disclosed herein. Detectors for other potentially dangerous enclosures such as freezers, refrigerators, hope chests, shipping containers, storage lockers, gun safes, and vehicle trunks may also benefit from the incorporation of the presently disclosed technology, as well as for other dangerous gasses which may accumulate in vehicle cabins from vehicle batteries such as lead acid batteries and lithium ion batteries (e.g., hydrogen, carbon monoxide, carbon dioxide, etc.).

### Tiered-Sensor Power Management

One need in the art for many applications of such detection systems is for the detector to be portable and/or battery operated, or for a permanently installed detector to use minimal power to reduce vehicle battery drain and the like. Such a portable or battery operated device could potentially be moved from one enclosure to another easily, such as by a consumer without difficult installation. Such a permanently installed detector in a vehicle, for example, should be able to operate for days to weeks, and preferably longer, to protect cars which are parked for long periods of time without draining the vehicle battery dead. There are millions of existing vehicles, refrigerators, freezers, gun safes, hope chests and storage lockers which could benefit from a consumer-installable, battery-operated trapped occupant detection and alert system.

However, the present inventors have recognized that many of the advanced sensors, such as non-dispersive infrared (NDIR) CO₂ sensors and ultrasonic proximity sensors, require considerable amounts of power for continuous of these sensors and, while they are more accurate means for detecting occupants than other types of sensors, they can drain battery power too quickly for practical application. On the other hand, other sensors which are useful in detecting the possibility of an abandoned or trapped occupant in an enclosure, such as weight-activated switches, temperature sensors and PIR motion sensors, which require considerably less power to operate continuously and are therefore more conducive to battery-powered applications, exhibit serious coverage gaps in detection as compared to the coverage scenarios that can be achieved with the higher-power demanding types of sensors.

The present inventors have, therefore, devised a new and useful power management process and arrangement in which the families of useful sensors are grouped into two categories: lower power for continuous use, and higher power for event-driven use. In this manner, one or more lower power-consuming occupant detection sensors are used continuously or at least periodically, and upon detecting a possible occupant of the enclosure according to one or more of the lower-power-consuming occupant detection sensors, then one or more higher power-consuming occupant detection sensors are powered-up and used to confirm the detection of an occupant in the enclosure. If, within a period of time, the confirmation is not made, then the higher power sensor(s) is(are) powered down or put back into a sleep mode, while the lower power sensor(s) is(are) continued to be monitored continuously or periodically for another potential detection event.

The following table provides an exemplary grouping of sensor families. In practice, sensors may be grouped in more than two groups, such as multiple tiers, according to their power consumption, power up time, power down time, settling time, confidence level of the monitored condition, etc., such that a first family (tier) of sensors is monitored continuously or at least periodically, and a second through n^{th} family (tier) is only powered-up and monitored according to the events and conditions detected by the first group of sensors.

Table: Example Sensor Families
Family I: Lower Power and/or Lower Confidence
Temperature sensors, weight-activated sensors, door-activated
switches, seatbelt closure switch, passive infrared (PIR) motion
sensors, and accelerometers.
Family II: Higher Power and/or Higher Confidence
Ultrasonic proximity sensors, laser-based gas sensors, NDIR gas
sensors, audio sensors, and image processors.

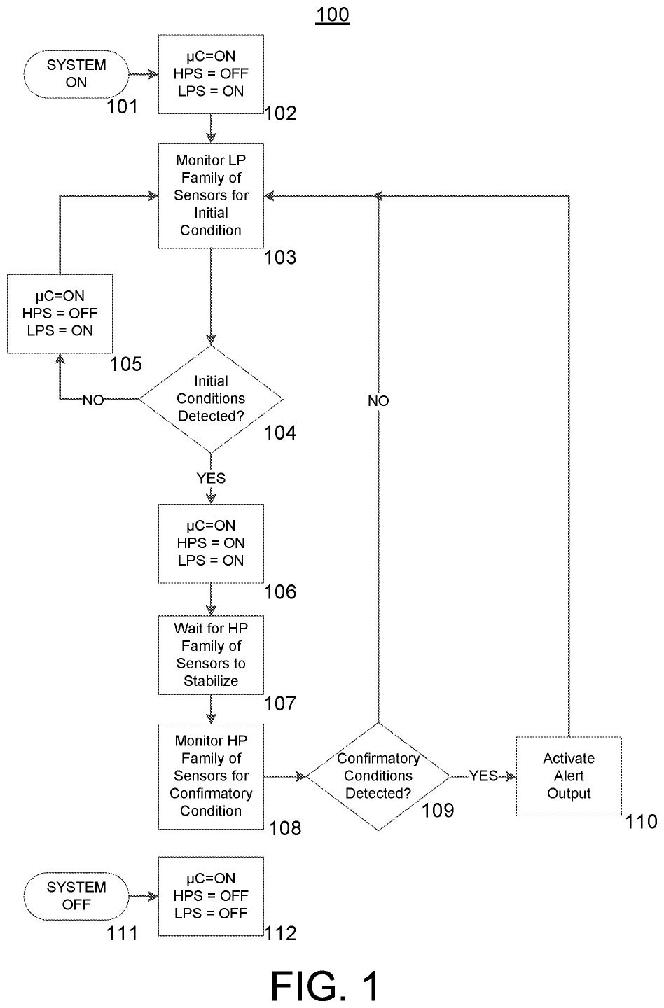

Turning to FIG. 1, an example logical process 100 according to the present invention suitable for execution by an embedded microcontroller (μC), programmable logic devices, or discrete analog logic, is shown. When the detection system is turned ON 101, the microcontroller sub-system is turned on as well as the low power-consuming occupant sensor family is turned on, such as one or more of temperature sensors, weight-activated sensors, door-activated switches, passive infrared (PIR) motion sensors, and accelerometers. The high(er) power-consuming family or families of occupant detection sensors are turned OFF at this stage.

Then, the low power-consuming sensors are monitored 103 by the embedded microcontroller or other suitable electronic logic for one or more initial conditions, such as a dangerous temperature, an increasing temperature, a weight sensor closure (weight applied to sensor), a door opened, a door closed, infrared motion sensed, and the system is in movement (acceleration). If any of these initial conditions are detected 104, which may indicate but is not certain to indicate reliably, a target condition being monitored, such as an abandoned child in a hot (or cold) vehicle, container, or storage cabinet, then one or more higher power-consuming sensors may be turned ON 106.

Following a suitable warm-up or stabilization period for the associated higher power-consuming occupant detection sensors 107, the higher power-consuming sensors are monitored 108 to detect one or more confirmatory conditions 109, such as, but not limited to, a one or more of dangerous level of CO₂, rising CO₂ levels, ultrasonic proximity sensor indication of an occupant moving, audio sensors indicating crying or barking, and image processors indicating an occupant in the vehicle, container, or storage cabinet.

If one or more of the confirmatory conditions is detected 109, then one or more alert outputs may be activated 110, such as flashing lights, audio annunciators, transmitting a wireless command, transmitting one or more telecommunications messages, etc. Then, the initial conditions are monitored 103 until they are abated 104, at which time the higher power-consuming sensors 105 are optionally turned OFF to preserve battery power. When the detection system is turned OFF 111, then the microcontroller subsystem and all sensor families are turned OFF 112.

In this manner, lower power but lower confidence level sensors are used to detect initial conditions of a possible dangerous situation, either current existing or predicted to exist shortly, while the higher power and higher confidence level sensors are only powered up during a confirmatory phase following detection of the initial condition(s).

In the configuration of a portable detector for abandoned children and pets in a hot car, a low power-consumption door sensor, temperature sensor and weight sensor under a seat can be combined to determine when, and if, a CO₂ sensor or PIR sensor should be powered up an monitored to confirm both the existence of a hot car (or heating up car) and an occupant inside. In such a configuration and embodiment, the present inventors recommend a quickly-settling non-dispersive infrared (NDIR) CO₂ sensor, such as the CozIR-Blink [TM] available from Gas Sensing Solutions™ Ltd. of Cumbernauld, United Kingdom, which has a settling time of less than 3.5 seconds, or suitable alternative CO₂ sensor with suitably quick settling time to the first valid reading.

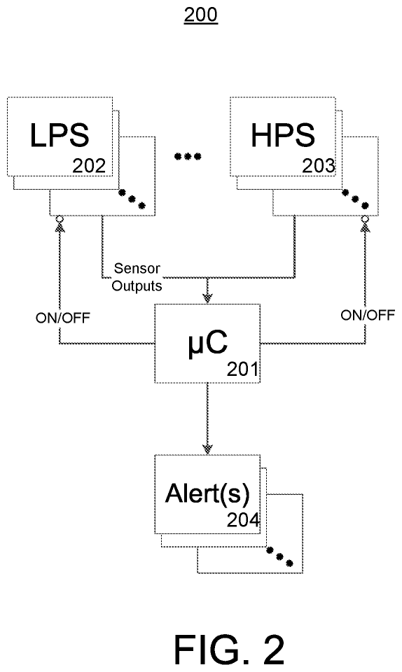

Referring now to FIG. 2, a high level block diagram 200 is shown for a detector system architecture according to the present invention, in which a microcontroller subsystem 201 can control power (ON/OFF) to at least two families of lower power-consuming sensors 202 and higher power-consuming systems 203. One or more alert outputs 204 may be activated and deactivated by the microcontroller subsystem 202, as previously described, and optionally in further accordance with the methods, processes, and circuits as described in U.S. Pat. No. 10,217,344, issued Feb. 26, 2019, and U.S. Pat. No. 10,457,200, issued Oct. 29, 2019, both to Michael T. Gage, et al.

### Microcontroller Computing Platform

Regarding computers for realization of the specialized embedded control computer, some embodiments may incorporate a computer or embedded microprocessor with requisite memory, processing, and communications capacities. Some embodiments may utilize an operating system, and it may allow for installing of other logical processes to extend, modify or revise the logical processes already on board the analyzer. Specialized co-processors or accelerators, such as graphics accelerators, and suitable computer readable memory devices (RAM, ROM, disk drives, removable memory cards, etc.), may also be incorporated into the specialized analyzer computer. One or more communications and/or network interfaces may be provided, such as Wi-Fi, Ethernet, USB, cellular data, IrDA, etc., as well as specialty interfaces, such as CAN bus, may also be provided in some implementations of the specialized analyzer computer. If the analyzer is intended to interact directly with human users, it may be provided with one or more user interface devices, such as display(s), keyboards, pointing devices, speakers, etc. Each computing platform may also be equipped with one or more power supplies (battery, AC mains, solar, etc.).

### Alert Outputs

As previously stated, if one or more of the confirmatory conditions is detected 109, then one or more alert outputs may be activated 110, such as flashing lights, audio annunciators, transmitting a wireless command, transmitting one or more telecommunications messages, etc. Some of these alert outputs may consume considerable power when not being used to issue an alert, i.e., while idle. For example, in one embodiment, the alert system may make an alert output on a wireless radio frequency (RF) or infrared (IR) band to emulate a vehicle key fob command, such as emulation of pressing an alarm button a key fob, pressing a door-unlock button on a key fob, or pressing a remote-start button on a key fob. This key fob emulation interface may be, in such an embodiment, powered down until the confirmatory alert condition(s) are detected by the system. In another embodiment, a cellular telephone interface may be incorporated to transmit messages, such as but not limited to E911 messages, social media posts, Short Message Service (SMS) text messages, etc. To save battery power, this cellular telephone interface may be powered off until the confirmatory alert conditions are detected by the system. In another embodiment, a wired interface to a vehicle control bus, such as but not limited to a Controller Area Network (CAN) bus, may be used to produce an alert output, such as a command to one or more of the vehicle's subsystems to perform a remedial action, such as but not limited to unlocking doors, rolling down windows, honking a horn, flashing exterior lights, engaging air conditioning or a heater, etc. In such an embodiment, the vehicle control bus may be grouped into the higher power-consumption functions and powered OFF until a confirmatory condition is detected.

### CONCLUSION

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof, unless specifically stated otherwise.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

It will be readily recognized by those skilled in the art that the foregoing example embodiments do not define the extent or scope of the present invention, but instead are provided as illustrations of how to make and use at least one embodiment of the invention.

I/We claim:

1. A system for reducing power consumption in an active occupant monitoring system comprising:
a first group of occupant presence sensors having one or more occupant sensors;
a second group of occupant presence sensors having one or more occupant sensors, wherein the one or more occupant presence sensors of the second group consume more power when enabled than the power consumed by the one or more occupant presence sensors of the first group when enabled; and
a power controller circuit configured to:
enable the one or more occupant presence sensors of the first group while disabling the one or more occupant presence sensors of the second group;
monitor the one or more enabled first group occupant presence sensors;
responsive to one or more enabled first group occupant presence sensors indicating a possible presence of an occupant, enable one or more occupant presence sensors of the second group; and,
responsive to one or more of the enabled second group occupant presence sensors confirming presence of an occupant, generating an alert output.

2. The system as set forth in claim 1 wherein the first group of occupant presence sensors comprises one or more sensors selected from the group consisting of a temperature sensor, a weight-activated sensor, a door-activated switch, a passive infrared (PIR) motion sensor, and an accelerometer.

3. The system as set forth in claim 1 wherein the second group of occupant presence sensors comprises one or more sensors selected from the group consisting of a carbon dioxide sensor, an ultrasonic proximity sensor, an audio sensor, and an image processor.

4. The system as set forth in claim 1 wherein the alert output comprises one or more alert output comprises an alert selected from the group consisting of a flashing light, an audio annunciator, a transmitted wireless vehicle command, a transmitted emulated key fob command, a transmitted telecommunications messages, an emergency cellular phone call, an emergency cellular message, a text message, a social media posting, and a vehicle control bus command.

5. The system as set forth in claim 1 wherein the power controller circuit comprises an embedded microcontroller.

6. The system as set forth in claim 1 wherein the power controller circuit comprises a electronic logic circuit.

8. A method for reducing power consumption in an active occupant monitoring system comprising:
enabling, by an electronic circuit, one or more occupant presence sensors within a first group while disabling the one or more occupant presence sensors within a second group, wherein the first group of occupant presence sensors has one or more occupant sensors, wherein the second group of occupant presence sensors has one or more occupant sensors, and
wherein the one or more occupant presence sensors of the second group consume more power when enabled than the power consumed by the one or more occupant presence sensors of the first group when enabled;
monitoring, by an electronic circuit, the one or more first group occupant presence sensors;
responsive to one or more enabled first group occupant presence sensors indicating a possible presence of an occupant, enabling, by an electronic circuit, one or more occupant presence sensors of the second group; and,
responsive to one or more of the enabled second group occupant presence sensors confirming presence of an occupant, generating, by an electronic circuit, an alert output.

9. The method as set forth in claim 8 wherein the first group of occupant presence sensors comprises one or more sensors selected from the group consisting of a temperature sensor, a weight-activated sensor, a door-activated switch, a passive infrared (PIR) motion sensor, and an accelerometer.

10. The method as set forth in claim 8 wherein the second group of occupant presence sensors comprises one or more sensors selected from the group consisting of a carbon dioxide sensor, an ultrasonic proximity sensor, an audio sensor, and an image processor.

11. The method as set forth in claim 1 wherein the alert output comprises one or more alert output comprises an alert selected from the group consisting of a flashing light, an audio annunciator, a transmitted wireless vehicle command, a transmitted emulated key fob command, a transmitted telecommunications messages, an emergency cellular phone call, an emergency cellular message, a text message, a social media posting, and a vehicle control bus command.

12. The system as set forth in claim 1 wherein the electronic circuit comprises an embedded microcontroller.

13. The system as set forth in claim 1 wherein the electronic circuit comprises a electronic logic circuit.
